(19) United States
(12) Patent Application Publication
(10) Pub. No.: US 2022/0151137 A1
(43) Pub. Date: May 19, 2022

(54) PNEUMATIC SOYBEAN SEED METER

(71) Applicant: Jose Roberto do Arnaral Assy, Caldas Novas (BR)

(72) Inventors: Jose Roberto do Amaral Assy, Caldas Novas (BR); Fernando Setton Sanches, Sao Paulo (BR); Douglas Candido Cavalcante, Tatuape (BR); Thiago Borges Nunes, Parque Paulistano (BR)

(21) Appl. No.: 17/438,670

(22) PCT Filed: Mar. 9, 2020
(86) PCT No.: PCT/BR2020/050075

§ 371 Date: Sep. 13, 2021

(30) Foreign Application Priority Data
Mar. 13, 2019 (BR) 10 2019004859 0

(51) Int. Cl. A01C 7/10; A01C 7/12

(52) U.S. Cl. CPC A01C 7/10; A01C 7/127

(57) ABSTRACT

The present disclosure relates generally to precision agriculture. More specifically, the disclosure relates to systems for metering and distributing seeds in planting fields. The disclosure refers to a pneumatic seed metering device that provides an optimized seed distribution for soybean planting. The meter releases the soybean seeds by vacuum cutting and letting the seeds fall by gravity. A seed disk is equipped with a plurality of seed holes spaced radially along a seed passage region, and the seed disk drive is performed at a peripheral region of the seed disk. The plurality of seed holes are arranged in a single row with a distance between two consecutive seed holes being in a range of 2.1 to 3.5 times the diameter of one of the seed holes, the diameter of the holes being defined in a range of 3.5 to 4.5 mm.

### TECHNICAL FIELD

The present disclosure relates generally to precision agriculture. More specifically, the disclosure relates to systems for metering and distributing seeds in planting fields.

### BACKGROUND

Since ancient times, agriculture has played a key role in the social and economic development of countries. In Brazil, for example, the agricultural sector employs a large number of people and drives the economy to global levels with exports of food and raw materials.

One of the main agricultural products cultivated in Brazilian territory is the soybean. Brazil is the second largest soybean producer in the world, only behind the United States.

Although it is not the world's largest producer of soybeans, Brazil is the largest exporter of the species. According to surveys by the Brazilian Agricultural Research Corporation—EMBRAPA—in the 2017/2018 harvest, soybean production in Brazil was 116,996 million tons, with productivity of 3,333 kg/ha, while soybean production in the U.S. reached rates of 119,518 million tons, with productivity of 3,299 kg/ha.

In view of the economic importance of soy production, Brazil has recently used resources to develop and improve productivity, especially with regard to the quality of seed distribution. These investments have resulted in soybean productivity indices in Brazil significantly higher than in some countries where the quality of seed distribution is still not as highly valued, such as, for example, the United States and Argentina. This trend, started in Brazil, has begun to spread to other countries.

Thus, the leading role of agricultural activities in the Brazilian economy generated investments in research that have been systematically applied in studies for the improvement of technologies that provide greater productivity in crops. Investments in the genetic improvement of the legume have been particularly abundant, and this has led to a recent and strong trend to demand a better spatial distribution of soybean seeds. This demand is already well known in corn, a grass that is traditionally demanding in terms of spatial distribution.

One of the most significant factors, albeit a recent trend, affecting the productivity of each acre planted with soybeans is seed distribution. With the recent advance in soybean breeding, when seeds are planted very close together in a field, the seeds compete for sunlight, water, and other resources. This competition negatively affects the growth of these plants, resulting in lower crop productivity for farmers. On the other hand, when seeds are planted too far apart, seed density and crop productivity decrease, resulting in waste and lost sales for farmers.

Thus, the spatial arrangement of the plants directly influences the crop productivity, so that very close seeds can increase sowing density, but it can cause future losses due to competition between plants for resources. When it comes to soybeans, the ideal spacing between rows is generally 35 cm to 50 cm and the distribution of seeds in each row is, depending on the soybean variety, from 6 to 35 seeds per meter. For the most common varieties of soybeans, generally the ideal range for soybean seed distribution is about 20 to 22 seeds per meter.

Thus, seed meters with deed disks having multiple rows of seed holes (e.g., multi-row disks) are sometimes used. Such seed disks may include two rows of seed holes (called double-row disks) or three rows of seed holes (called triple-row disks) to achieve a distribution of more than 15 seeds per meter without the need for high-speed seed disk rotation. However, despite improving the quantity of seeds per meter, multi-row disks present a natural setback in the parallel movement of seeds in the disk, which tend to come closer to each other when they are released and fall under the action of gravity. When using conventional metering units with single row seed disks in soybean planting, the seed disk rotations required to meet the quantities per meter are high and the results are often disastrous as well. Conventional single row disk meters, because they cannot perform well at high disk rotation speeds, use larger diameter disks so that the disk rotation is not high, which generates other problems such as vibrations and difficulties in regulating corresponding singulators or in determining a proper disk position.

Generally, the quality of seed distribution is evaluated by the “coefficient of variation”, also abbreviated and known as “CV”. The CV for planting is a relative measure of variability with which the seeds are distributed in the soil, that is, it is a measure that indicates how far the seeds deposited in the soil are outside the ideal position defined by the farmer. Thus, a lower CV corresponds to a higher-quality planting.

The main parameters that influence the planting CV, regarding the seed metering in the seed distribution process, are the speed of the planters and the speed of rotation of the seed metering disks. Generally speaking, these factors of meter design and performance determine the precision in the distribution and final disposition of seeds in the planting area.

In addition to factors based on seed metering design and performance, other factors that also influence seed distribution are irregularities in the soil and the presence of obstacles in the path of the planting line, which can compromise the quality of seed deposition. This is because they affect the planter and cause disordered movements of seeds, especially at the time of release and, therefore, can cause failures (no seeds) or doubles (two seeds instead of one) in the distribution of seeds in the soil.

In the seed meter, other factors that influence seed metering are the quantity and dimensions of the disk holes. These holes have specific quantities and diameters depending on the seed to be planted and the desired seed populations per meter. More specifically, seed disks with a greater number of holes have the advantage of transporting more seeds per rotation, thus demanding lower rotational speeds during operation.

On the other hand, the greater the number of holes, the smaller the spacing between adjacent holes and, consequently, the smaller the spacing between the seeds on the disk. The greater proximity between the seeds on the seed disk increases the probability that some mechanical disturbance in the system may cause a seed from one hole to be deposited in the soil close to a seed from another adjacent hole. Thus, disks with a greater number of holes may have an increase in CV.

In order to improve the CV, single-row disk meters are used. However, conventional single-row disk meters maintain a low CV only at low rotations, due to the need for a greater number of holes to meet the demand for seeds per meter. When higher planter speeds are required, the disks require high rotations (e.g., above 30 RPM) to meet the desired amount of seeds per meter. However, conventional meters with conventional disks, at rotations above 30 RPM, suffer more from the effects of natural micro-oscillations from the movement of planters in the soil and lose singularization capacity. Therefore, there is a substantial increase in CV and loss in planting quality.

With regard to soybeans destined for export, cultivation is mostly done in extensive flat terrains, with the use of heavy machinery and the adoption of crop rotation in order to maximize productivity and profit from additional harvests of other crops. Productivity gains occur through the adoption of planters and seed meters, which are used together in the mechanization of precision planting. There is a recent trend towards increasing planting speed for efficiency gains, due to the so-called flat terrain, which added to the recent and growing demand for better soybean seed distribution, resulted in the inspiration for the soybean metering unit of the present disclosure.

Generally, in pneumatic seed meters, one of the components responsible for seed singularization is the seed disk. This disk has holes arranged radially to capture the seeds through the pressure difference between their faces. Once captured, the seeds are transported to a metering outlet opening where the vacuum generated by the pressure difference between the faces of the disk is cut and the seeds are released to go to the soil by the action of gravity or other means of transport.

Good seed distribution results from each hole in the disk containing only one seed. The duality of seeds per hole, also called pairs or doubles, as well as the absence of seeds in the holes, also known as failures, compromise the final dispersion of seeds. In order to avoid the multiplicity of seeds in the same hole, singulators are used.

There are some consolidated singularization mechanisms in the market, such as the one described in patent U.S. Pat. No. 7,699,009 B2, by Sauder et al. This mechanism describes a system of springs that press the singulators against a shoulder of the seed disk to ensure accurate placement of the singulators over the holes in the seed disk.

One reason the use of precision singulators is necessary is the fact that disks can have a dimensional difference inherent in the injection processes during manufacturing. This is because, as much as the disks have dimensional differences in manufacturing, as the distance from the holes to the periphery is small, the variation in this region is minimized. In this way, the precision singulator solutions described above use the low-variance region as a reference to ensure proper positioning, since the position of the singulator tip is kept constant with respect to the holes.

Another solution for the precision singularization of seeds in the meter is described in U.S. Patent Publication No. 2017/0303463, by Assy et al. In this document, the seed disk rotates in a ring supported by a system of rails that keep the disk in a constant radial and axial position in relation to the singulators arranged in the ring and, therefore, results in a precise positioning of the singulators over the seed disk holes.

Yet another factor that can affect the accuracy of the meters is the drive of the disks, since a non-precision drive, such as traditional ones made by the central axis of the disk, can generate mechanical disturbances and impacts that cause unwanted movement of the seeds. Thus, there is a growing trend to develop pneumatic metering with precision drives as described in U.S. Pat. No. 6,752,095 B1, by Rylander et al., in which the disks are driven by the edges by an independent controlled energy source. However, the systems known as the state of the art still present a high CV in the distribution of seeds in the soil, which, consequently, can cause losses to farmers. The CV increases even more when a higher rotation speed of the seed disks is necessary to keep up with the planter's movement speed, so that conventional systems present significant variations when they exceed 30 RPM.

Thus, although apparently functional to date, the conventional systems have some drawbacks and limitations related to maintaining planting accuracy as increasingly higher speeds of seed disk rotation are demanded to meet farmers' needs.

### BRIEF SUMMARY

In order to circumvent the inconveniences of the state-of-the-art devices and to achieve the objectives mentioned above, among others, this description deals with a pneumatic soybean seed meter, which releases the soybean seeds by vacuum cutting and lets the seeds fall by action of gravity, in which it comprises a seed disk provided with a plurality of seed holes radially spaced along a seed path region and a seed singulator disposed on the seed disk. The drive of the seed disk may be performed by a peripheral region of the seed disk, in which the plurality of holes is arranged in a single row with a distance between two consecutive holes in a range of 2.1 to 3.5 times the diameter of one of the holes, and the diameter of the holes is defined in a range of 3.5 to 4.5 mm.

According to additional embodiments of the present disclosure, the pneumatic soybean seed meter comprises a seed singulator disposed on the seed disk, considering that the singulator needs to be precision to ensure good singularization even at high disk rotations, the precision seed singulator is of a floating type and is interdependent with respect to the seed disk. The interdependence of the seed singulator with the seed disk is configured by the region of the seed disk used with reference to position the singulators.

In one embodiment, the reference used is an outer shoulder of the seed disk, with the singulators resting on the outer shoulder of the seed disk to position the singulators over the seed disk holes and improve precision in seed singularization.

In another embodiment, the seed singulator utilizes an inner track ring system on the seed disk, in which the singulators are supported on the inner seed disk track to also position the singulators over the seed disk holes and improve accuracy in seed singularization.

According to a another embodiment of the present disclosure, the rotational range of the seed disk is functional and with a low coefficient of variation even above 50 RPM and up to 100 RPM.

### BRIEF DESCRIPTION OF THE DRAWINGS

The objectives, advantages, technical and functional improvements of embodiments of the present disclosure will be better understood from the reading of the descriptions of their particular achievements, made below in relation to the attached figures, which illustrate ways of particular achievements, and not limiting, in which:

FIG. 1 shows a front view of a seed meter according to an embodiment of the present disclosure;

FIG. 2 shows a perspective view of a seed meter according to an embodiment of the present disclosure;

FIG. 3 shows a front view of a seed meter with the lid open according to an embodiment of the present disclosure;

FIG. 4 shows a perspective view of a seed meter with an open lid according to a realization of the present disclosure;

FIG. 5 shows a front view of a seed disk according to an embodiment of the present disclosure;

FIG. 6 shows a perspective view of a seed disk according to an embodiment of the present disclosure;

FIG. 7 shows a top sectional view of a disk with a rail-guided singulator system;

FIG. 8 shows a front view of a seed disk with a system of singulators supported on the shoulder of the seed disk;

FIG. 9 shows a top sectional view of a disk with a singulator system supported on the shoulder of the seed disk;

FIG. 10 shows the interaction of the singulators with the seed disk holes;

FIG. 11 shows a representation of the variation in seed distribution in the soil using a prior art single row seed disk;

FIG. 12 shows a representation of the variation in seed distribution in the soil with the use of a seed disk according to an embodiment of the present disclosure; and

FIG. 13 shows a representation of the variation in seed distribution in the soil using a prior art double row seed disk.

### DETAILED DESCRIPTION

The present disclosure is now described with respect to its particular achievements, making reference to the attached figures. In the following figures and description, similar parts are marked with the same reference numbers. The figures are not necessarily drawn to scale, i.e., certain features of the present disclosure may be shown with exaggeration of scale or in some schematic way, as well as details of conventional elements may not be shown in order to illustrate this description more clearly and concisely. The present disclosure is susceptible to the embodiments in different ways. Specific embodiments are described in detail and shown in the figures, with the understanding that the description is to be regarded as an exemplification of the principles disclosed herein, and is not intended to be limited to only what is illustrated and described in this disclosure. It must be recognized that the different teachings of the achievements discussed below may be employed separately or in any suitable combination to produce the same technical effects.

The present disclosure will be described hereinafter particularly with respect to pneumatic seed meters 1 for planting soybeans, also referred to below as seed meter 1 or simply meter 1. Although functional for other crops (such as beans and corn), the present disclosure has an especially superior performance for soybeans due to the dynamics provided by the more rounded shape of the legume seeds and by the eventual greater rotation of the disks when planting soybeans due to high quantities, higher speeds, and the inter-row spacing normally used with the crop.

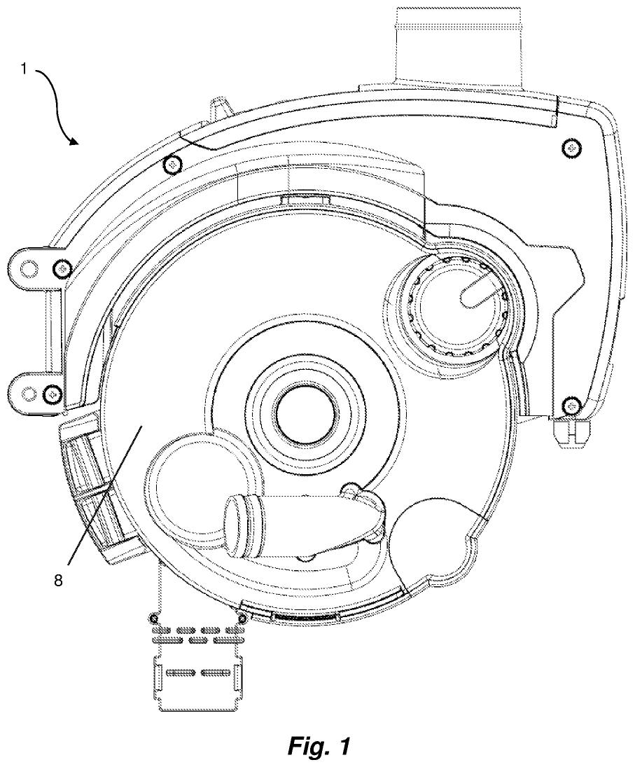

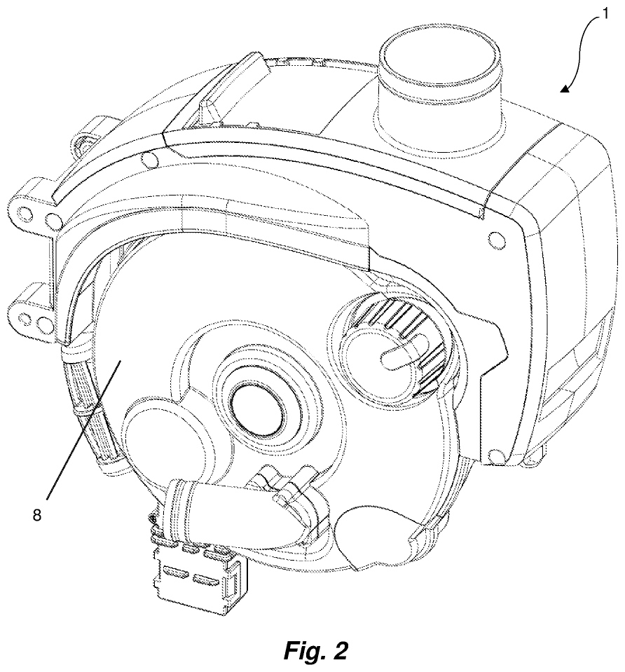

FIGS. 1 and 2 illustrate a pneumatic seed meter 1 in its assembled and closed form according to an embodiment of the disclosure. Although FIGS. 1 and 2 illustrate specific and preferred aspects of a meter, the present disclosure can be applied to other pneumatic meter patterns.

Although the dimensions of the meters 1 may vary considerably between different brands and models, the present disclosure can be applied to the most varied dispensers known on the market while maintaining the same efficiency, since the main features of the present disclosure are related to features of seed disk 2, seed disk 2 drive system, and precision singulators.

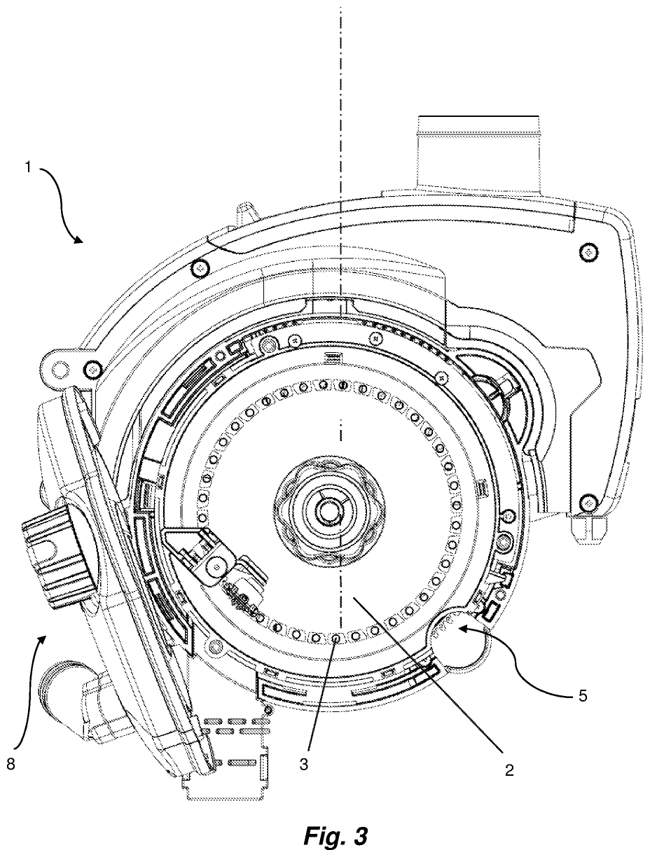

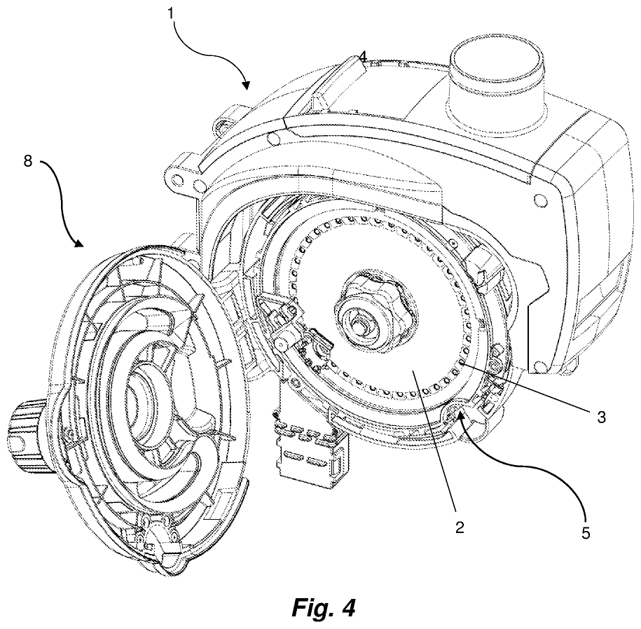

Some of the characteristics of the seed disks 2 of the present disclosure can be seen in FIGS. 3 and 4, in which the seed disk 2 has seed holes 3 and an outer shoulder 5, being illustrated mounted inside the seed meter 1 with the 8 cover open.

When operating a seed meter 1 with high rotational speeds of seed disk 2, small disturbances can negatively influence the quality of seed distribution in large proportions. Thus, some precision items, such as the singulators and the means for activating the seed disk 2, are important to reduce (e.g., avoid or minimize) disturbances in the dosage of seeds and ensure the correct functioning of embodiments of the present disclosure.

In the case of singulators, the use of singulators with low precision or that are improperly adjusted starts to improperly remove the seeds from the holes as soon as the seed disk 2 reaches high rotations.

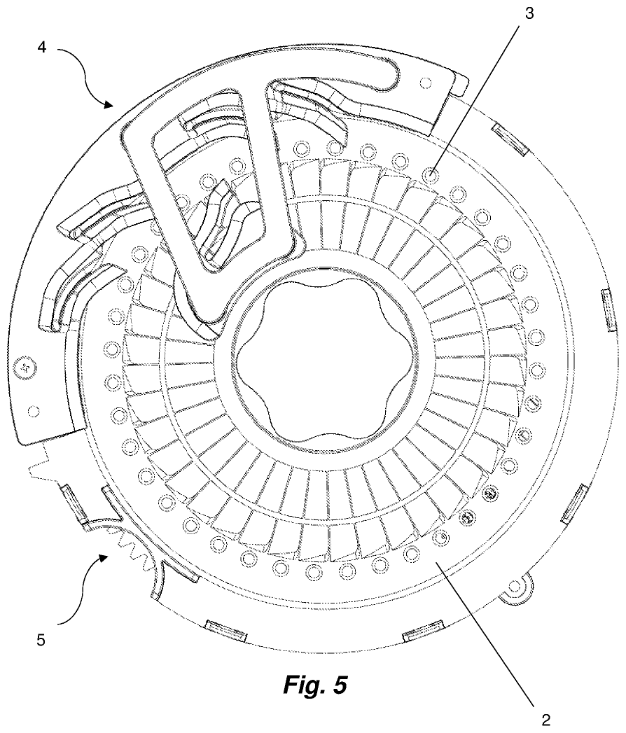

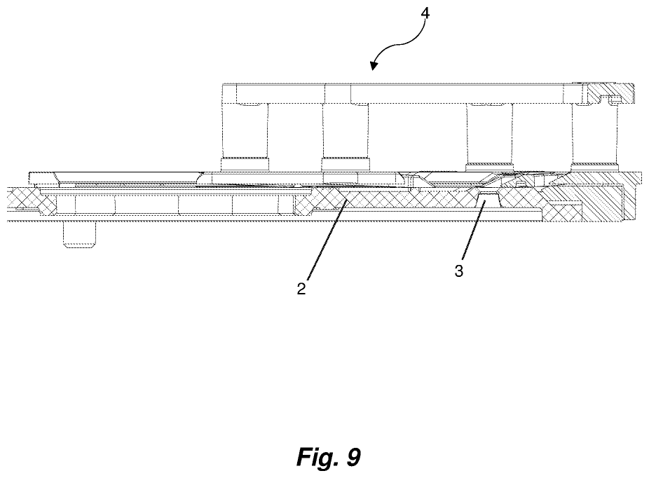

Thus, the present disclosure provides for the use of seed singulator systems 4 (FIGS. 5-10) that ensure the proper positioning of the seed singulators 4 on the seed disks 2, in particular with respect to the arrangement of the singulators 4 over the holes 3.

Such singulators 4 are called “precision singulators” and work through mechanisms that keep the singulators in a constant position relative to the seed disk 2. More specifically, the precision seed singulators 4 are floating and interdependent with respect to seed disk 2, that is, the precision singulators follow the movement of seed disk 2, so there is no relative movement per se, only of rotation of the seed disk under the singulators.

Advantageously, the precision seed singulators 4 do not need manual adjustments as the positioning mechanisms automatically adjust the position of the singulators 4 in relation to the seed disks 2. This feature is especially useful for seed meters 1 that can work from 15 RPM to up to 100 RPM, since the dynamics of seed disk rotation can considerably vary the interaction of singulators with seeds depending on increasing rotational speed of the seed disk.

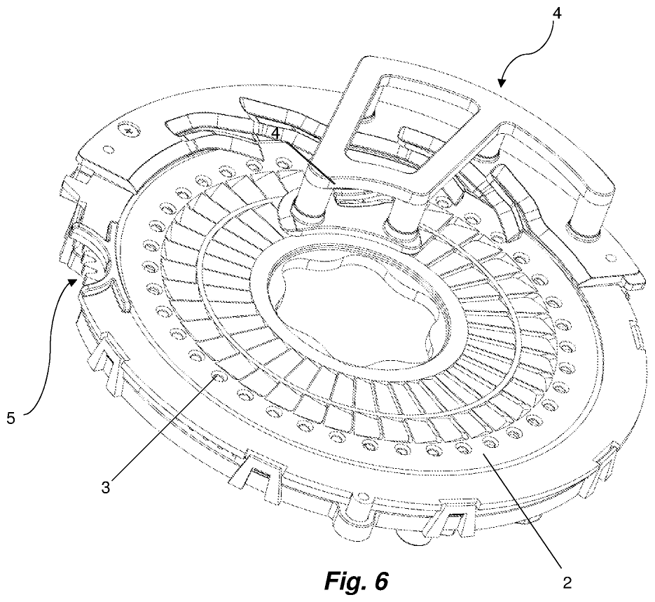

In one embodiment of the present disclosure, as illustrated in FIGS. 5 and 6, the seed disk 2 is associated with one of the types of precision seed singulators 4, which guarantees the accuracy of the positioning of the singulators by means of a positioning system with a ring 7 and rail 6.

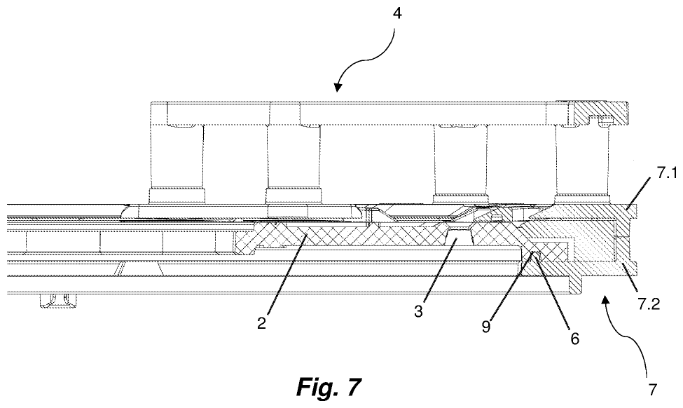

The precision positioning system with ring 7 and rail 6 is composed of an upper part of the ring 7.1 and a lower part of the ring 7.2, which fit onto the seed disk 2 and surround at least a peripheral region of the seed disk 2. Further, the lower part of the ring 7.1 comprises an inner rail 6 that fits into a recess 9 in the seed disk and ensures that the seed disk 2 and the ring 7 move in solidarity to provide precise positioning of the singulators over the holes 3 in the seed disk 2, as illustrated in FIG. 7.

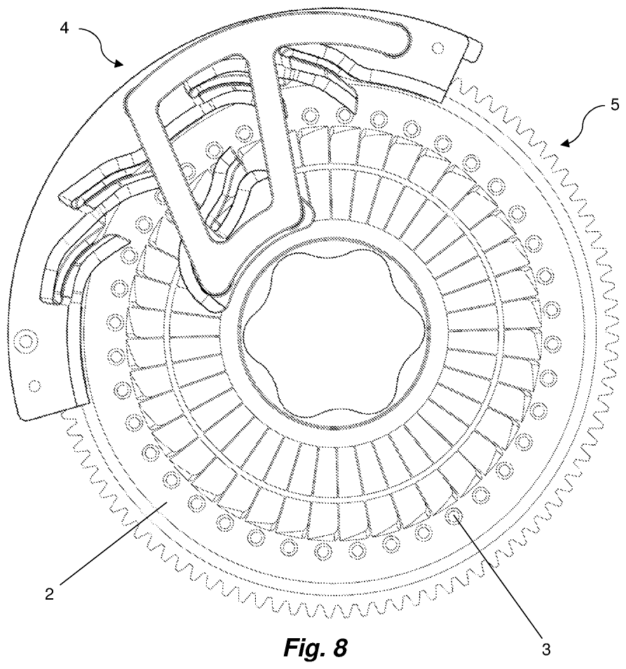

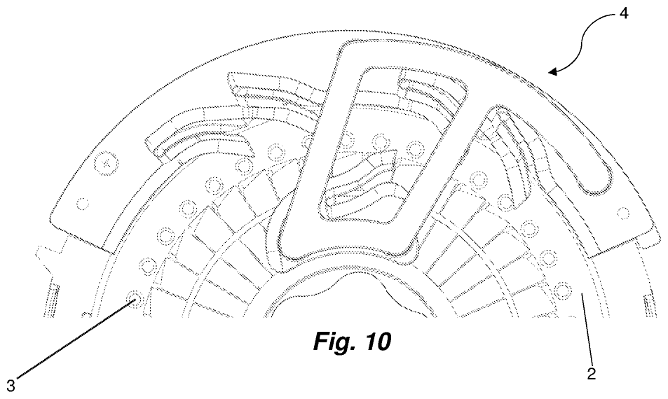

In another embodiment of the present disclosure, illustrated in FIG. 8, the precision system for positioning the singulators 4 over the holes 3 is formed by a set of singulators 4 supported on the shoulder 5 of the seed disk 2 and is held in position by means of springs or other mechanisms that direct and maintain the singulator sets 4 resting on the shoulder 5 of the seed disk 2. In this realization, the singulators 4 are not mounted relative to the seed disk 2, but show good accuracy since, although mobile relative to the seed disk 2, they are directed against the shoulder 5 of the seed disk 2 to keep the tip of the singulators 4 positioned over the seed holes 3. FIG. 10 shows in more detail the positioning of the singulators 4 in relation to the holes 3 of the seed disk 2 according to an embodiment of the present disclosure.

Regarding the means of driving seed disk 2, it is also helpful to use precision systems to obtain uniform rotation of seed disk 2.

In an embodiment of the present disclosure, a drive means (not shown) coupled to the peripheral region of the seed disk 2 is used. In this embodiment, the seed disk 2 is pulled by a toothed edge by means of a motor or other source of mechanical energy.

In a more specific embodiment of the present disclosure, with an arrangement of seed holes (3) spaced apart with a distance of 3.1 times the diameter of 4.0 mm of the seed holes, the capture and release of the seeds in high rotations (above 50 RPM) is optimized. Under the same conditions of planter speed and seed disk 2 rotation, variations in the number of holes for fewer holes tend to worsen seed capture and variations in the number of holes for more holes tend to worsen seed release.

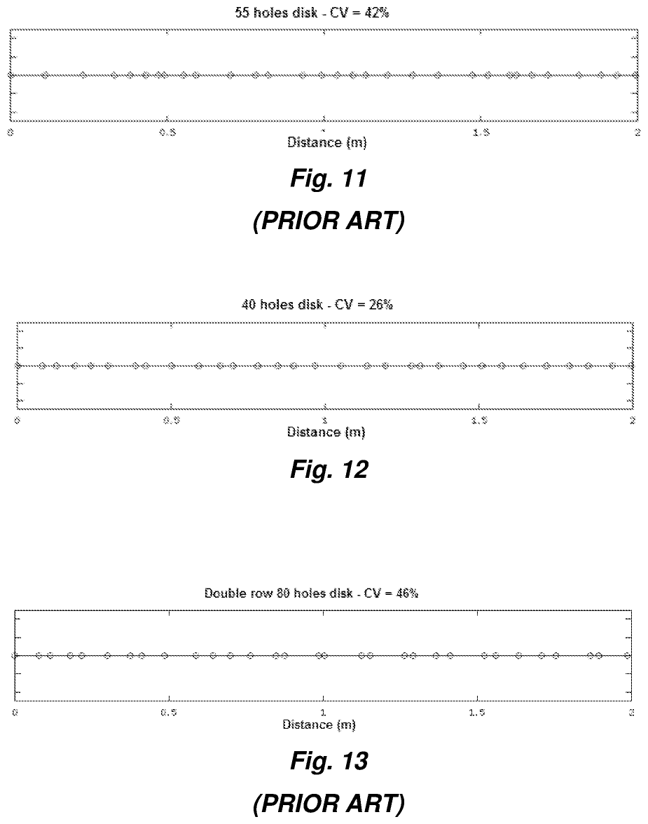

In field tests with disks rotated by the periphery and with precision singulators, endowed with varying amounts and configurations of holes, working at high speed (e.g., above 50 RPM) it was found that a disk according to an embodiment of the present disclosure, endowed with a single row with forty holes spaced apart by 3.1 times the diameter of the holes present better distribution of soybean seeds than a conventional disk of the same size and single row with fifty-five holes, as illustrated in the representations of seed distribution in the FIGS. 11 and 12. The performance difference was much less expressive or null, with the absence of precision singulators and actuation by the periphery or at low rotational speeds of less than 50 RPM.

Also in field tests, the 40-hole disk, as an embodiment of the present disclosure, also showed better seed distribution results than a double-row disk of equivalent dimensions under equal seed population conditions, as can be seen in comparison between FIGS. 12 and 13.

Furthermore, in tests with speed variations using a disk according to a realization of the present disclosure, it was found that in the rotational speed range from 0 to 50 RPM, a subtle improvement can be observed in relation to the distribution of seeds obtained in the state of the art, and with speeds of 50 to 100 RPM the result is far superior.

In particular, a disk of 40 holes in a single row, with 4.0 mm holes spaced 12.3 mm apart, according to an embodiment of the present disclosure, is able to plant, still with quality, 30 soybean seeds per meter in a planter with speed of 8 km/h and disk rotation at 100 RPM, with a peripheral drive and precision singulators. Under these planting conditions (30 soybean seeds per meter at 8 km/h), a seed disk with multiple rows would result in a very high CV, with a high incidence of failures and doubles in the seed distribution in the soil. The absence of periphery drive and precision singulators, even with a 40-hole disk, would also result in poorer performance.

Therefore, in some embodiments of the present disclosure, the soybean seed metering concepts of the present disclosure are able to eliminate or at least reduce the limitations of technologies known in the prior art. Since there has recently been a demand for better spatial distribution of soybean seeds in the planting furrow, due to improvements in soybean productivity, especially due to its genetic evolution.

In addition, one of the potential advantages of the present disclosure is to provide a seed meter that provides a linear distribution of seeds even with high planter movement speeds, a recent trend that causes high rotations of the meter disks.

Still, another potential advantage of the present disclosure is to provide a seed disk that allows the distribution of seeds with quality and in sufficient quantity to meet the demand of planters with high speeds, which cause high rotations of the metering disks.

It is also a potential advantage of the present disclosure to provide an optimized relationship between the size and arrangement of holes in the seed disk in order to provide a metering system that supports high seed disk rotational speeds with seed distribution quality.

Another potential advantage of the present disclosure is to provide a seed meter with optimized dimensions to improve the capture and release of seeds at high rotations.

It is also a potential advantage of the present disclosure to provide a meter that provides a quality distribution of soybean seeds, where with only one disk model this same great performance can be achieved at low, medium and high rotational speeds of the soybean planting disk, simplifying the operation thereof.

Another potential advantage of the present disclosure providing a distribution of seeds with higher rotations and with a quality equal or superior to what conventional systems deliver. This allows the disks to be smaller. Consequently, the meters can be smaller, which facilitates and saves cost in manufacturing.

More specifically, pneumatic meters are generally made of polymeric materials that, when used in the production of reduced size elements, present greater dimensional stability and material savings. In other words, the manufacture of smaller meters makes its components suffer less deformation and warping, in addition to being cheaper because they use less raw material.

Furthermore, it is a potential advantage of the present disclosure to provide subsidies for an easier and more accurate manufacture of the meters, as the greater the capacity to support high speeds of disk rotation with quality soybean seed distribution, the smaller the possible construction diameter of the meter. This may optimize the quality of the manufacturing, as you can have greater dimensional control.

Thus, the present disclosure has advantages in relation to the state of the art and contributes to the technological development of the agricultural sector, especially for precision soybean planting.

Although the present disclosure has been specifically described in relation to particular achievements, it should be understood that variations and modifications will be evident to technicians in the subject matter and can be done without departing from the scope of protection of the present disclosure. Consequently, the scope of protection is not limited to the achievements described, but is limited only by the attached claims, the scope of which must include all equivalents.

What is claimed is:

1. A pneumatic soybean seed meter that releases the soybean seeds by vacuum cutting and letting the seeds fall by gravity action, comprising:
a seed disk including a plurality of seed holes radially spaced along a seed path region, the seed disk being driven by a peripheral region of the seed disk,
wherein:
the plurality of seed holes are arranged in a single row;
two consecutive seed holes of the plurality of seed holes are spaced apart by a distance in a range of 2.1 to 3.5 times the diameter of one of the seed holes; and
the diameter of each seed hole of the plurality of seed holes is in a range of 3.5 mm to 4.5 mm.

2. The pneumatic soybean seed meter of claim 1, further comprising a seed singulator coupled to the seed disk.

3. The pneumatic soybean seed meter of claim 2, wherein the seed singulator is a floating-type precision seed singulator that is interdependent with respect to the seed disk.

4. The pneumatic soybean seed meter of claim 1, wherein rotation of the seed disk rotation maintains a coefficient of variation level of less than about 42% at rotational speeds above 50 RPM.

5. The pneumatic soybean seed meter of claim 1, wherein the rotation operational range of the seed disk is up to 100 RPM.
